(19) United States
(12) Patent Application Publication
(10) Pub. No.: US 2007/0070447 A1
(43) Pub. Date: Mar. 29, 2007

(54) Scanning module of image scanner

(75) Inventor: Hsi-Yu Chen, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/280,495

(22) Filed: Nov. 16, 2005

(30) Foreign Application Priority Data
Sep. 27, 2005 (TW) 094133457

(51) Int. Cl. H04N 1/04

(52) U.S. Cl. 358/474

(57) ABSTRACT

The present invention relates to a scanning module of an image scanner. The scanning module has plural reflective mirrors. The position of one reflective mirror is adjusted by two screws to adjust a light reflective angle of the mirror.

### FIELD OF THE INVENTION

The present invention relates to a scanning module, and more particularly to a scanning module with screw holes for adjusting a reflective angle of a mirror.

### BACKGROUND OF THE INVENTION

To fulfill users' requirement, in addition to image quality, how to reduce the size of image scanners is also an important topic.

In general, an image scanner comprises a scanning module, a PC board, and a transmission mechanism for driving the scanning module. Among which, the scanning module occupies most internal space of the image scanner. Therefore, it is desirable for scanner designers to reduce the scanner size by means of thinning the volume of scanning module.

A scanning module comprises all optical elements of scanner. They comprise a light tube, an image sensor, such as charge coupled device, a lens and reflective mirrors. Light projected on document is reflected by plural mirrors and transmitted to the lens and the image sensor.

In the prior art, reflective mirrors are fixed in scanning module by hooks. The hooks are integrated with the housing of scanning module and are made of plastic material. It is unavoidable that the positions of the hooks will have errors during the manufacturing process and influence the correct reflective angles of mirrors.

For a scanner which has a larger volume, the influence of the reflective angle won't result in optical path error. However, for a scanner which has a thin scanning module, even a tiny error of reflective angle will result in unrecoverable error in optical path.

It is therefore a requirement to provide a scanning module which can adjust the reflective angle of a reflective mirror.

### SUMMARY OF THE INVENTION

It is an object of the present invention to provide a scanning module with an adjusting mechanism for adjusting the reflective angle of a reflective mirror.

According to a preferred embodiment of this invention, there is provided a scanning module for an image scanner, for generating image signals of document and having a rectangular housing for containing an image sensor, a lens and plural reflective mirrors therein, the scanning module further comprising:
two hooks, set inside the housing for fixing one of the plural reflective mirrors;
two screw holes, set at two ends of a longer sidewall of the housing respectively; and
two screws, passing through the two screw holes respectively and contacting the hooks.

In a preferred embodiment, the hooks are integrated with the housing.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a perspective view of a scanning module according to a preferred embodiment of the present invention;

FIG. 2 is a schematic side view of the scanning module of FIG. 1;

FIG. 3 is a schematic top view of the scanning module of FIG. 1.

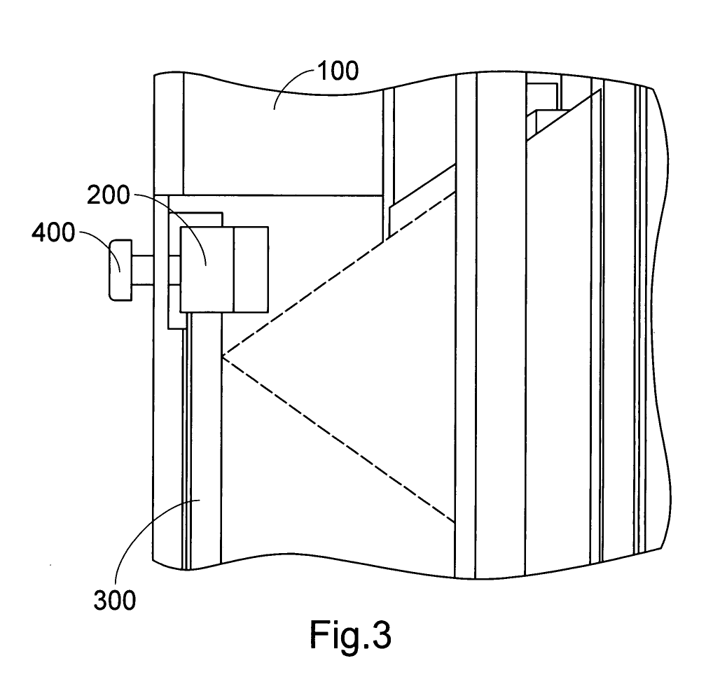

### DETAILED DESCRIPTION OF THE PREFERRED EMBODIMENT

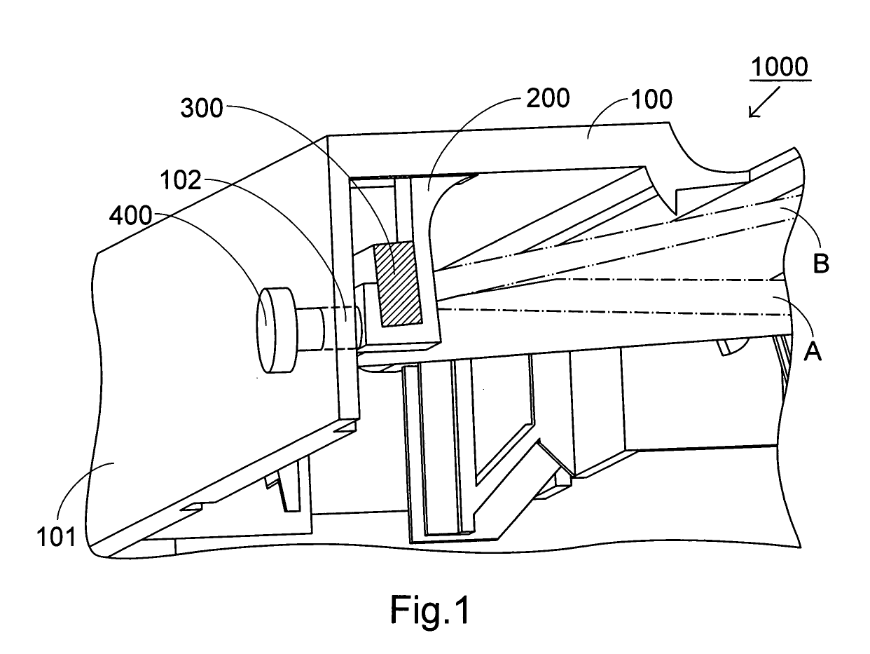

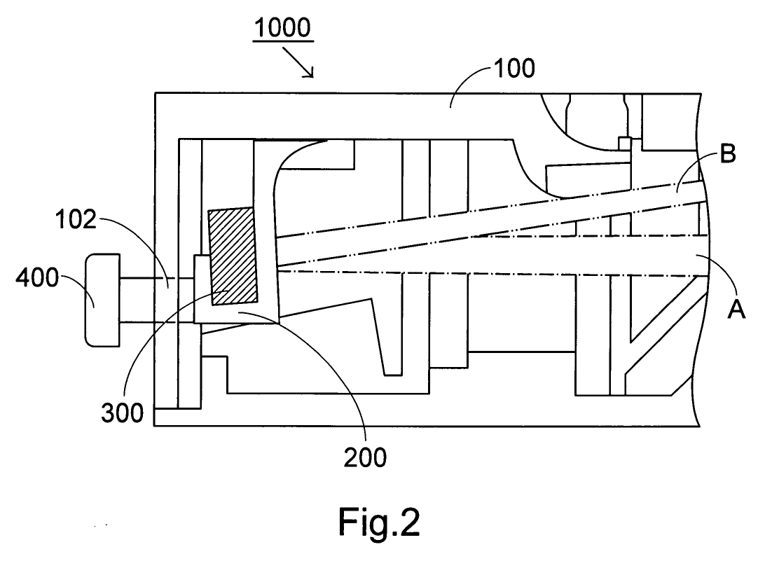

Please refer to FIGS. 1,2 and 3 which schematically illustrate perspective, side and top views of a scanning module of the present invention, respectively. FIG. 1 shows a scanning module 1000 comprising a rectangular housing 100 having a longer sidewall 101, a hook 200, a reflective mirror 300 and a screw 400. FIG. 2 shows a screw hole 102.

It is noted that FIG. 1,2 and 3 only show the elements which relate to the feature of the invention and do not show the conventional image sensor and lens. Besides, there is another screw hole and another screw set at the opposite end of the longer sidewall 101. For simplifying, only one screw hole and one screw shown in the figures.

Please refer to FIG. 1, a reflective mirror 300 is fixed inside the housing 100 near the longer sidewall 101. And there are two screw holes 102 at two ends of the longer sidewall 101 respectively. The screw 400 passes through the screw hole 102 to contact the hook 200.

When the mirror 300 is hold by the hook 200, the real optical path B reflected by mirror 300 is not in the direction of a correct optical path A, as shown in FIG. 1. During manufacturing process, by rotating screws 400 to shift the hooks 200 by a tiny distance, the light reflective angle of mirror 300 can be adjusted and therefore the real optical path B can be adjusted toward the direction of correct optical path A, as shown in FIG. 2.

The real optical path B can be measured to make sure that it conforms to the correct optical path A. After that, glue is dropped on the screw holes to fix screws.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A scanning module for an image scanner, for generating image signals of document and having a rectangular housing for containing an image sensor, a lens and plural reflective mirrors therein, characteristic in that the scanning module further comprising:
two hooks, set inside the housing for fixing one of the plural reflective mirrors;
two screw holes, set at two ends of a longer sidewall of the housing respectively; and
two screws, passing through the two screw holes respectively and contacting the hooks.

2. The scanning module according to claim 1, wherein the hooks are integrated with the housing.
